(19) United States
(12) Patent Application Publication
(10) Pub. No.: US 2014/0308472 A1
(43) Pub. Date: Oct. 16, 2014

(54) PACKAGING BODY OF MEDICAL ADHESIVE SHEET

(71) Applicants: Hiroaki Hasegawa, Suita-shi (JP); Ryuichi Yamada, Ushiku-shi (JP)

(72) Inventors: Hiroaki Hasegawa, Suita-shi (JP); Ryuichi Yamada, Ushiku-shi (JP)

(73) Assignees: NIPPON SHOKUBAI CO., LTD., Osaka-shi, Osaka (JP); HOGY MEDICAL CO., LTD., Tokyo (JP); NIPPON SHOKUBAI CO., LTD., Osaka-shi, Osaka (JP); HOGY MEDICAL CO., LTD., Tokyo (JP)

(21) Appl. No.: 14/354,439

(22) PCT Filed: Oct. 26, 2012
(86) PCT No.: PCT/JP2012/077681

§ 371 Date: Apr. 25, 2014

(30) Foreign Application Priority Data
Oct. 28, 2011 (JP) 2011-238011

(51) Int. Cl. C09J 7/02

(52) U.S. Cl. CPC C09J 7/0232
USPC 428/41.8

(57) ABSTRACT

Provided is a packaging that is for a medical adhesive sheet, results from housing a medical adhesive sheet resulting from a peelable liner being pasted to the surface to which an adhesive agent layer has been formed of a resin film having the adhesive agent layer, and is characterized by: the medical adhesive sheet being folded in a manner so that the surface to which the peelable liner is provided is the inner surface and the surface to which the resin film is provided is the outer surface; the folded medical adhesive sheet being sandwiched between packaging sheets; and the packaging sheets being sealed at the ends thereof.

### TECHNICAL FIELD

The present invention relates to a packaging body of a medical adhesive sheet. More specifically, the present invention relates to a packaging body of a medical adhesive sheet which is useful, for example, for an incise drape used in surgery, and the like.

### BACKGROUND ART

Bacterial infection in the surgical site during surgery is often caused by bacteria which is attached to a skin or bacteria which normally exists in the skin. Therefore, the skin is disinfected before surgery. However, it is difficult to completely remove bacteria from the skin although the number of bacteria existing in the skin can be reduced by skin disinfection.

Accordingly, the Japanese Association for Operative Medicine has published “Practice Guideline for Surgical Treatment” (see, for example, Non-patent Literature 1). It is described in this guideline that an incise drape which is a thin transparent or translucent film used in such a manner that the incise drape is attached to a skin, and the skin is incised on the incise drape for the purpose of preventing a surgical wound from contamination of skin resident bacteria, is expected to reduce the influence of the skin resident bacteria which causes a surgical site infection in clean-contaminated operation such as cardiac surgery, neurosurgery or orthopedic surgery.

As described in this “Practice Guideline for Surgical Treatment,” surgery using an incise drape has become common in recent years from the viewpoint of the prevention of infection. The incise drape generally includes, for example, a thin transparent thermoplastic resin film on which an adhesive layer is formed. The surface of the adhesive layer is protected by lamination with a release liner on which a release agent layer is formed.

A major purpose for using an incise drape is to prevent the migration of skin resident bacteria to the incision layer. When the incise drape has a crease, a gap is formed between a skin and the incise drape through which skin resident bacteria may migrate to the incision layer. Hence, it has been desired to develop an incise drape which has no creases when the incise drape is attached to a skin, or an incise drape which can reduce the formation of creases to an extent such that the invasion of skin resident bacteria is inhibited from the gap between a skin and the incise drape even when the incise drape has some creases.

As a conventional incise drape, there has been proposed an incise drape which can be easily applied to a patient by oneself (see for example, Patent Literature 1). In this incise drape, as shown in FIG. 2 of the Patent Literature 1, an adhesive portion 9 including a pressure-sensitive adhesive layer is formed on a transparent flexible film 21. A release liner 16 is provided on the adhesive portion 9, and the release liner 16 is provided with handles 14 and 15. Also, FIGS. 3 to 5 show an incise drape which is folded so that the release liner 16 forms an inner surface and the film 21 forms an outer surface.

However, when this incise drape is folded in the above manner, and inserted into a packaging bag, the end of the film 21 of the incise drape is caught at the end of the opening of the packaging bag, and the film 21 is exfoliated from the incise drape. Therefore, there is a possibility to cause the lowering of quality of the incise drape. In order to eliminate this defect, a folded incise drape is usually wrapped with a packaging paper (inserting paper) such as a paper or a film. However, after the incise drape is taken out from the packaging bag, the above-mentioned packaging paper is unnecessary and becomes a waste. Therefore, it has been desired that the use of a packaging paper is avoided from the viewpoint of the protection of earth resources.

As an incise drape which does not necessitate a packaging paper, it can be thought that the incise drape is folded so that its release liner forms an outer surface, and its film forms an inner surface. However, when the incise drape is folded in such a manner, creases are formed on the film, and the thickness of the adhesive layer formed on the incise drape becomes uneven at the folded portion. Therefore, folding the incise drape as mentioned above is not considered to be an appropriate measure.

### PRIOR ART DOCUMENTS

### Patent Literature

Patent Literature 1: Japanese Patent No. 4142103

### Non-Patent Literature

Non-patent Literature 1: Practice Guidelines for Surgical Treatment Drafting Committee, “Practice Guideline for Surgical Treatment”, August 2008, Japanese Association for Operative Medicine [searched on Aug. 2, 2011 by Internet <URL:http://jaom.umin.ne.jp/new1001020.html>

### SUMMARY OF THE INVENTION

### Problems to be Solved by the Invention

The present invention has been made in view of the above prior art. An object of the present invention is to provide a packaging body of a medical adhesive sheet which does not necessitate a packaging paper for packing an incise drape, and has high qualities such that a film which constitutes an incise drape has no creases, and that no separation is existed at the end of the film.

### Means for Solving the Problems

The present invention relates to:

(1) A packaging body of a medical adhesive sheet, in which the medical adhesive sheet is included, wherein the medical adhesive sheet includes a resin film having an adhesive layer to which a release liner is attached; wherein the above-mentioned medical adhesive sheet is folded so that the face of the release liner forms an inner surface, and the face of the resin film forms an outer surface; and wherein the folded medical adhesive sheet is put between sheets for packaging, and the periphery of the sheets for packaging is sealed;

(2) the packaging body of a medical adhesive sheet according to the above-mentioned (1), wherein the medical adhesive sheet is folded by winding the medical adhesive sheet so that the face of the resin film forms an outer surface; and

(3) the packaging body of a medical adhesive sheet according to the above-mentioned (1) or (2), wherein the adhesive layer is formed from an acrylic adhesive.

### Effects of the Invention

The packaging body of a medical adhesive sheet of the present invention does not necessitate a packaging paper for packing an incise drape, and has high qualities such that a film which constitutes an incise drape has no creases, and that no separation is existed at the end of the film.

### MODES FOR CARRYING OUT THE INVENTION

As described above, the packaging body of a medical adhesive sheet of the present invention is a packaging body of a medical adhesive sheet, in which the medical adhesive sheet is included, wherein the medical adhesive sheet includes a resin film having an adhesive layer to which a release liner is attached, wherein the above-mentioned medical adhesive sheet is folded so that the face of the release liner forms an inner surface, and the face of the resin film forms an outer surface, and wherein the folded medical adhesive sheet is put between sheets for packaging, and the periphery of the sheets for packaging is sealed.

Since the packaging body of a medical adhesive sheet of the present invention has the above-mentioned constituents, the packaging body of a medical adhesive sheet does not necessitate a packaging paper for packing an incise drape, and has high qualities such that a film constituting an incise drape has no creases, and that no separation is existed at the end of the film.

In the medical adhesive sheet, a release liner is attached to the surface of the adhesive layer which is formed on the resin film.

The resin film includes, for example, a resin film of an olefin resin such as polyethylene, polypropylene or ethylene-vinyl acetate copolymer; a resin film of a polyester such as polyethylene terephthalate or polybutylene terephthalate; a resin film of a styrene resin such as polystyrene; a resin film of a vinyl chloride resin such as polyvinyl chloride; a resin film of a urethane resin such as polyether urethane or polyester urethane; a resin film of a polyamide such as nylon-6 or nylon-6,6; a resin film of a (meth)acrylic resin such as a (meth)acrylic acid polymer, a (meth)acrylate polymer, an acrylonitrile polymer or an acrylamide polymer; and the like, and the present invention is not limited only to those exemplified ones. The resin film of the above resin may have a single layer or can be composed of a laminate made of two kinds of resin films.

The thickness of the resin film cannot be absolutely determined because the thickness varies depending on the kind of a resin which constitutes the resin film. The thickness of the resin film is usually preferably 5 μm or more, more preferably 10 μm or more, and further preferably 20 μm or more from the viewpoint of increase in mechanical strength, and is preferably 100 μm or less, more preferably 80 μm or less, and further preferably 60 μm or less from the viewpoint of improvement in flexibility.

The size of the resin film cannot be absolutely determined because the size varies depending on its uses. For example, in the course of producing an original fabric having a width of 1000 to 1500 mm and a length of 200 to 2000 m or so, preferably 1000 to 2000 m or so for producing a medical adhesive sheet, the original fabric can be cut into a size suitable for its uses, for example, a size of 100 to 1500 mm or so in length and 100 to 1000 mm or so in width.

The adhesive resin used in the adhesive includes, for example, for example, an acrylic adhesive resin, a silicone adhesive resin, a urethane adhesive resin, a vinyl alkyl ether adhesive resin, a rubber and the like, and the present invention is not limited only to those exemplified ones. These adhesive resins can be used alone or in combination of at least two kinds within the scope which would not hinder an object of the present invention.

Among the adhesive resins, the acrylic adhesive resin is preferable, and the acrylic adhesive resin obtained by polymerizing a monomer component containing an acrylic acid alkyl ester as a main component is more preferable, because the acrylic adhesive resin is excellent in adhesion property and constant load peeling resistance, can be applied to various adherends, and is also excellent in versatility.

Incidentally, the above-mentioned “a monomer component containing an acrylic acid alkyl ester as a main component” means that the content of the acrylic acid alkyl ester in the monomer component is 50% by mass or more. The content of the acrylic acid alkyl ester in the monomer component is 50% by mass or more, preferably 60% by mass or more, more preferably 70% by mass or more, and further preferably 80% by mass or more from the viewpoint of improvement in adhesion property.

Among acrylic acid alkyl esters, an acrylic acid alkyl ester having an alkyl group of 1 to 18 carbon atoms is preferable from the viewpoint of preparation of an acrylic adhesive resin which is excellent in adhesion property, can be applied to various adherends, and is also excellent in versatility. A suitable acrylic acid alkyl ester includes, for example, methyl(meth)acrylate, ethyl(meth)acrylate, n-propyl(meth)acrylate, isopropyl(meth) acrylate, n-butyl(meth) acrylate, sec-butyl(meth) acrylate, tert-butyl(meth)acrylate, isobutyl(meth) acrylate, n-pentyl(meth) acrylate, isopentyl(meth)acrylate, n-hexyl(meth)acrylate, cyclohexyl acrylate, n-heptyl(meth)acrylate, n-octyl(meth) acrylate, isooctyl(meth) acrylate, 2-ethylhexyl(meth) acrylate, n-nonyl(meth) acrylate, isononyl(meth) acrylate, n-decyl(meth)acrylate, isodecyl(meth)acrylate, n-dodecyl(meth)acrylate, isomyristyl(meth) acrylate, n-tridecyl(meth) acrylate, n-tetradecyl(meth)acrylate, n-stearyl(meth) acrylate, isostearyl(meth) acrylate, n-lauryl(meth)acrylate, isomyristyl(meth)acrylate, isostearyl(meth)acrylate and the like; and the present invention is not limited only to those exemplified ones. These acrylic acid esters can be used alone or in combination of at least two kinds. Among these acrylic acid alkyl esters, n-butyl acrylate, n-octyl acrylate, isooctyl acrylate and 2-ethylhexyl acrylate are preferable, and n-butyl acrylate and 2-ethylhexyl acrylate are more preferable from the viewpoint of improvement in adhesion property.

Incidentally, in the present specification, the “(meth)acrylate” means “acrylate” or “methacrylate,” and the term “(meth)acryl” means “acryl” or “methacryl”.

The monomer component may contain a monomer other than the acrylic acid alkyl ester within the scope which would not hinder an object of the present invention. The monomer other than the acrylic acid alkyl ester includes, for example, a monomer having a carboxyl group, a monomer having a hydroxyl group, an acidic phosphate monomer, a monomer having an epoxy group, a monomer having a nitrogen atom, a monomer having two or more polymerizable double bonds, an aromatic monomer, a monomer having a halogen atom, a vinyl ester monomer, a vinyl ether monomer and the like; and the present invention is not limited only to those exemplified ones. These monomers can be used alone or in combination of at least two kinds. Among these monomers, the monomer having a carboxyl group and the monomer having a hydroxyl group are preferable.

The monomer having a carboxyl group includes, for example, acrylic acid, methacrylic acid, itaconic acid, maleic anhydride and the like, and present invention is not limited only to those exemplified ones. These monomers having a carboxyl group can be used alone or in combination of at least two kinds. Among these monomers having a carboxyl group, acrylic acid, methacrylic acid, itaconic acid and maleic anhydride are preferable, and acrylic acid and methacrylic acid are more preferable.

The monomer having a hydroxyl group includes, for example, hydroxyalkyl(meth)acrylates having a hydroxyalkyl group of 2 to 4 carbon atoms, such as 2-hydroxyethyl acrylate, 2-hydroxyethyl methacrylate, hydroxypropyl acrylate, hydroxypropyl methacrylate, hydroxybutyl acrylate and hydroxybutyl methacrylate, and the like, and the present invention is not limited only to those exemplified ones. These monomers having a hydroxyl group can be used alone or in combination of at least two kinds.

The acidic phosphate monomer includes, for example, 2-acryloyloxyethyl acid phosphate, 2-methacryloyloxyethyl acid phosphate and the like, and the present invention is not limited only to those exemplified ones. These acidic phosphate monomers can be used alone or in combination of at least two kinds.

The monomer having an epoxy group includes, for example, (meth)acrylic acid esters having an epoxy group, such as glycidyl acrylate and glycidyl methacrylate, and the like, and the present invention is not limited only to those exemplified ones. These monomers having an epoxy group can be used alone or in combination of at least two kinds.

The monomer having a nitrogen atom includes, for example, (meth)acrylamides such as acrylamide and methacrylamide; (meth)acrylates having a nitrogen atom, such as N,N′-dimethylaminoethyl acrylate, N,N′-dimethylaminoethyl methacrylate, N,N-diethylaminoethyl acrylate, N,N-diethylaminoethyl methacrylate, imide acrylate and imide methacrylate; and the like, and the present invention is not limited only to those exemplified ones. These monomers having a nitrogen atom can be used alone or in combination of at least two kinds.

The monomer having two or more polymerizable double bonds includes, for example, ethylene glycol diacrylate, ethylene glycol dimethacrylate, triethylene glycol diacrylate, triethylene glycol dimethacrylate, tripropylene glycol diacrylate, tripropylene glycol dimethacrylate, trimethylolpropane triacrylate, trimethylolpropane trimethacrylate, pentaerythritol tetraacrylate, pentaerythritol tetramethacrylate and the like, and the present invention is not limited only to those exemplified ones. These monomers having two or more polymerizable double bonds can be used alone or in combination of at least two kinds.

The aromatic monomer includes, for example, styrene and styrene compounds such as α-methylstyrene, and the like, and the present invention is not limited only to those exemplified ones. These aromatic monomers can be used alone or in combination of at least two kinds.

The monomers having a halogen atom include, for example, vinyl halides such as vinyl chloride and the like, and the present invention is not limited only to those exemplified ones. These monomers having a halogen atom can be used alone or in combination of at least two kinds.

The vinyl ester monomer includes, for example, a fatty acid vinyl such as vinyl acetate, and the like, and the present invention is not limited only to those exemplified ones. These vinyl ester monomers can be used alone or in combination of at least two kinds.

The vinyl ether monomers includes, for example, butyl vinyl ether, cyclohexyl vinyl ether and the like, and the present invention is not limited only to those exemplified ones. These vinyl ether monomers can be used alone or in combination of at least two kinds.

The content of the monomer other than the acrylic acid alkyl ester in the monomer component is 50% by mass or less, preferably 40% by mass or less, more preferably 30% by mass or less, and further preferably 20% by mass or less from the viewpoint of improvement in adhesion property.

When the monomer component is polymerized, a chain transfer agent can be used as occasion demands from the viewpoint of inhibition in increase of molecular weight distribution and gelation. The chain transfer agent includes, for example, mercaptocarboxylic acids such as mercaptoacetic acid and 3-mercaptopropionic acid; mercaptocarboxylic acid esters such as methyl mercaptoacetate, methyl 3-mercaptopropionate, 2-ethylhexyl 3-mercaptopropionate, n-octyl 3-mercaptopropionate, methoxybutyl 3-mercaptopropionate, stearyl 3-mercaptopropionate, trimethylolpropane tris(3-mercaptopropionate), pentaerythritol tetrakis(3-mercaptopropionate) and dipentaerythritol hexakis(3-mercaptopropionate); alkyl mercaptans such as ethyl mercaptan, tert-butyl mercaptan, n-dodecyl mercaptan and 1,2-dimercaptoethane; mercapto alcohols such as 2-mercaptoethanol and 4-mercapto-1-butanol; aromatic mercaptans such as benzenethiol, m-toluenethiol, p-toluenethiol and 2-naphthalenethiol; mercaptoisocyanurates such as tris[(3-mercaptopropionyloxy)ethyl]isocyanurate; disulfides such as 2-hydroxyethyl disulfide or tetraethylthiuram disulfide; dithiocarbamates such as benzyl diethyldithiocarbamate; dimers such as α-methylstyrene dimer; alkyl halides such as carbon tetrabromide; and the like, and the present invention is not limited only to those exemplified ones. These chain transfer agents can be used alone or in combination of at least two kinds. Among these chain transfer agents, the compounds having a mercapto group such as a mercaptocarboxylic acid, a mercaptocarboxylic acid ester, an alkyl mercaptan, a mercapto alcohol, an aromatic mercaptan and a mercaptoisocyanurate are preferable since these compounds are easily available, excellent in anti-crosslinking properties, and low in lowering degree of a polymerization rate.

The amount of the chain transfer agent can be suitably determined in accordance with polymerization conditions such as composition of the monomer component and polymerization temperature, molecular weight of an objective polymer, and the like, and is not particularly limited. However, when a polymer having a weight average molecular weight of several thousands to several tens of thousands is prepared, the amount of the chain transfer agent is preferably 0.1 to 20 parts by mass, and more preferably 0.5 to 15 parts by mass per 100 parts by mass of the monomer component.

The method for polymerizing the monomer component includes, for example, bulk polymerization, solution polymerization, dispersion polymerization, suspension polymerization, emulsion polymerization and the like, and the present invention is not limited only to those exemplified ones.

The bulk polymerization can be carried out, for example, by irradiation with energy ray such as ultraviolet ray, electron beam or radioactive ray, heating, and the like. When the bulk polymerization of the monomer component is carried out by irradiation with an energy ray, it is preferable to polymerize the monomer component by, for example, irradiating the monomer component with an energy ray in an inert gas atmosphere such as nitrogen gas or an air-free atmosphere.

When the monomer component is polymerized by bulk polymerization, a photopolymerization initiator can be used. The photopolymerization initiator includes, for example, an acetophenone polymerization initiator, a benzoin ether polymerization initiator, a benzyl ketal polymerization initiator, an acyl phosphine oxide polymerization initiator, a benzoin polymerization initiator, a benzophenone polymerization initiator and the like, and the present invention is not limited only to those exemplified ones. These photopolymerization initiators can be used alone or in combination of at least two kinds. The amount of the photopolymerization initiator can be suitably determined in accordance with desired physical properties of an obtained polymer, and the like. The amount of the photopolymerization initiator is usually preferably 0.01 to 50 parts by mass, and more preferably 0.03 to 20 parts by mass per 100 parts by mass of the monomer component.

When the monomer component is polymerized by solution polymerization, the solvent includes, for example, organic solvents such as aromatic solvents such as toluene and xylene; alcohol solvents such as isopropyl alcohol and n-butyl alcohol; ether solvents such as propylene glycol methyl ether, dipropylene glycol methyl ether, ethyl cellosolve and butyl cellosolve; ester solvents such as ethyl acetate, butyl acetate and cellosolve acetate; ketone solvents such as acetone, methyl ethyl ketone, methyl isobutyl ketone and diacetone alcohol; and amide solvents such as dimethylformamide, and the present invention is not limited only to those exemplified ones. These solvents can be used alone or in combination of at least two kinds. The amount of the solvent can be suitably determined in consideration of the polymerization conditions, the composition of the monomer component, the concentration of the obtained polymer, and the like.

When the monomer component is polymerized by solution polymerization, a polymerization initiator can be used. The polymerization initiator includes, for example, dimethyl-2,2′-azobis-2-methyl propionate, 2,2′-azobis(2,4-dimethylvaleronitrile), 2,2′-azobis(2-methylbutyronitrile), tert-butyl peroxy-2-ethylhexanoate, 2,2′-azobisisobutyronitrile, benzoyl peroxide, di-tert-butyl peroxide and the like, and the present invention is not limited only to those exemplified ones. These polymerization initiators can be used alone or in combination of at least two kinds. The amount of the polymerization initiator can be suitably determined in accordance with desired physical properties of an obtained polymer and the like. The amount of the polymerization initiator is usually preferably 0.001 to 20 parts by mass, and more preferably 0.005 to 10 parts by mass per 100 parts by mass of the monomer component.

The polymerization conditions when the monomer component is polymerized can be suitably determined in accordance with a polymerization method, and are not particularly limited. The polymerization temperature is preferably from room temperature to 20° C., and more preferably 40 to 140° C. The reaction period of time can be suitably determined so that the polymerization reaction of the monomer component is completed. The monomer component is polymerized as described above, and thereby an acrylic adhesive resin is obtained.

The weight average molecular weight of the acrylic adhesive resin is preferably 1000000 to 2500000 or so from the viewpoint of allowing the adhesive layer formed on the medical adhesive sheet to have a viscosity suitable for the medical adhesive sheet.

Incidentally, in the present specification, the weight average molecular weight of the resin (polymer) is a value as determined by using tetrahydrofuran as a mobile phase, columns (produced by Tosoh Corporation under the trade name of TSK-gel SuperHM-H (two columns) and TSK-gel SuperH2000 (one column), and a gel permeation chromatography (produced by Tosoh Corporation under the trade name of HLC-8220 GPC) under the condition of a temperature of 40° C. and a flow rate of 0.3 mL/min, and converted into a value in terms of standard polystyrene.

In addition, among the adhesive resins, a sulfur bond-containing (meth)acrylic adhesive resin in which a mercapto group having three or more chain polymers is bonded to other mercapto groups via the chain polymers is preferable from the viewpoint of increase in adhesion property and cohesion. The raw material monomer of the chain polymer of this sulfur bond-containing (meth)acrylic adhesive resin is preferably a monomer containing a (meth)acrylic acid alkyl ester having 7 to 17 carbon atoms from the viewpoint of improvement in adhesion property. The content of the (meth)acrylic acid alkyl ester having 7 to 17 carbon atoms in the raw material monomer is preferably 50 to 100% by mass, more preferably 60 to 100% by mass, further preferably 70 to 100% by mass, furthermore preferably 80 to 100% by mass, and particularly preferably 90 to 100% by mass from the viewpoint of improvement in adhesion property.

The (meth)acrylic acid alkyl ester having 7 to 17 carbon atoms includes, for example, butyl(meth)acrylate, tert-butyl(meth)acrylate, pentyl(meth)acrylate, hexyl(meth)acrylate, heptyl(meth)acrylate, octyl(meth)acrylate, isooctyl(meth)acrylate, nonyl(meth) acrylate, isononyl(meth)acrylate, decyl(meth)acrylate, undecyl(meth)acrylate, dodecyl(meth)acrylate, 2-ethylhexyl(meth)acrylate and the like, and the present invention is not limited only to those exemplified ones. These (meth)acrylic acid alkyl esters can be used alone or in combination of at least two kinds.

Among the (meth)acrylic acid alkyl ester having 7 to 17 carbon atoms, from the viewpoint of improvement in adhesion property, octyl(meth)acrylate, isooctyl(meth) acrylate, nonyl(meth) acrylate, decyl(meth)acrylate and 2-ethylhexyl(meth)acrylate are preferable, octyl acrylate, isooctyl acrylate, nonyl acrylate, decyl acrylate and 2-ethylhexyl acrylate are more preferable, and 2-ethylhexyl acrylate is furthermore preferable.

In the raw material monomer, a monomer other than the (meth)acrylic acid alkyl esters having 7 to 17 carbon atoms (hereinafter referred to as “other monomer”) can be included. The content of the other monomer in the raw material monomer is preferably 0 to 50% by mass, more preferably 0 to 40% by mass, further preferably 0 to 30% by mass, furthermore preferably 0 to 20% by mass, and particularly preferably 0 to 10% by mass from the viewpoint of improvement in adhesion property.

The other monomer includes, for example, (meth)acrylic acid; (meth)acrylic acid alkyl esters having 6 or less carbon atoms, such as methyl(meth)acrylate and ethyl(meth)acrylate; (meth)acrylamides such as (meth)acrylamide, N-methyl(meth)acrylamide and N-propyl(meth)acrylamide; styrene monomers such as α-methylstyrene, vinyltoluene, and styrene; maleimide monomers such as phenyl maleimide and cyclohexyl maleimide; vinyl ether monomers such as methyl vinyl ether, ethyl vinyl ether and isobutyl vinyl ether; fumaric acid monomers such as fumaric acid, fumaric acid monoalkyl ester and fumaric acid dialkyl ester; maleic acid monomers such as maleic acid, maleic acid monoalkyl ester and maleic acid dialkyl ester; itaconic acid monomers such as itaconic acid, itaconic acid monoalkyl ester and itaconic acid dialkyl ester; vinyl pyrrolidones such as N-vinyl-2-pyrrolidone; alkoxypolyalkylene glycol(meth) acrylates such as methoxy triethylene glycol acrylate, methoxy polyethylene glycol methacrylate, ethoxy diethylene glycol acrylate and methoxy polyethylene glycol acrylate; other vinyl compounds such as (meth)acrylonitrile, butadiene, isoprene, vinyl chloride, vinylidene chloride, vinyl acetate, vinyl ketone, vinyl pyridine and vinyl carbazole; and the like, and the present invention is not limited only to those exemplified ones. These other monomers can be used alone or in combination of at least two kinds.

Among the other monomers, (meth)acrylic acid, methyl(meth)acrylate and vinyl acetate are preferable from the viewpoint of improvement in adhesion property and cohesion; the vinyl pyrrolidone such as N-vinyl-2-pyrrolidone is preferable from the viewpoint of the reduction of skin irritation caused by the sulfur bond-containing (meth)acrylic adhesive resin; and the alkoxypolyalkylene glycol(meth)acrylate is preferable from the viewpoint of improvement in moisture permeability of the sulfur bond-containing (meth)acrylic adhesive resin. The content of the alkoxypolyalkylene glycol(meth)acrylate in the raw material monomer is preferably 1% by mass or more, more preferably 5% by mass or more and further preferably 10% by mass or more from the viewpoint of improvement in moisture permeability of the sulfur bond-containing (meth)acrylic adhesive resin, and is preferably 45% by mass or less, and more preferably 40% by mass or less from the viewpoint of improvement in adhesion property of the sulfur bond-containing (meth)acrylic adhesive resin.

As a method for preparing the sulfur bond-containing (meth)acrylic adhesive resin, there can be cited, for example, a method for carrying out a multistage radical polymerization of a raw material monomer in the presence of a polyvalent mercaptan compound, in which the raw material monomer and a polyfunctional monomer are used in combination in at least one stage of the multistage radical polymerization.

The polyvalent mercaptan compound includes, for example, diesters of a carboxyl group-containing mercaptan and a diol such as an ethylene glycol compound such as ethylene glycol dithioglycolate, ethylene glycol dithiopropionate, 1,4-butanediol dithioglycolate or 1,4-butanediol dithiopropionate, or 1,4-butanediol; triesters of a carboxyl group-containing mercaptan and a triol such as a trimethylolpropane compound represented by trimethylolpropane trithioglycolate and trimethylolpropane trithiopropionate; polyesters of a carboxyl group-containing mercaptan and a compound having four hydroxyl groups, such as a pentaerythritol compound represented by pentaerythritol tetrakisthioglycolate and pentaerythritol tetrakisthiopropionate; polyesters of a carboxyl group-containing mercaptan and a compound having six hydroxyl groups, such as a dipentaerythritol represented by dipentaerythritol hexakisthioglycolate and dipentaerythritol hexakisthiopropionate; polyesters of a carboxyl group-containing mercaptan and a compound having three or more hydroxyl groups, such as trithioglycerol; triazine polythiols such as 2-di-n-butylamino-4,6-dimercapto-S-triazine and 2,4,6-trimercapto-S-triazine; compounds into which plural mercapto groups are introduced by adding hydrogen sulfide to plural epoxy groups of a polyvalent epoxy compound; esters of a polyvalent carboxylic acid having plural carboxyl groups and mercaptoethanol; and the like, and the present invention is not limited only to those exemplified ones. These polyvalent mercaptan compounds can be used alone or in combination of at least two kinds.

The carboxyl group-containing mercaptan includes, for example, compounds having one mercapto group and one carboxyl group, such as thioglycolic acid, mercaptopropionic acid and thiosalicylic acid.

The polyfunctional monomer is a compound having two or more polymerizable unsaturated groups in its molecule. The monomer having two polymerizable unsaturated groups in its molecule is a bifunctional monomer. The monomer having three polymerizable unsaturated groups in its molecule is a trifunctional monomer. Among the polyfunctional monomers, a bifunctional monomer and a trifunctional monomer are preferable from the viewpoint of inhibition of the gelation of a polymer.

The polyfunctional monomer includes, for example, diester compounds of (meth)acrylic acid and a diol such as ethylene glycol di(meth)acrylate, polyethylene glycol di(meth)acrylate, propylene glycol di(meth)acrylate, polypropylene glycol di(meth)acrylate, 1,3-butylene glycol di(meth)acrylate, 1,6-hexanediol di(meth)acrylate, neopentyl glycol di(meth)acrylate, 2-hydroxy-1,3-di(meth)acryloxy propane, 2,2-bis[4-(acryloxyethoxy)phenyl]propane, 2,2-bis[4-(methacryloxyethoxy)phenyl]propane, 2,2-bis[4-(acryloxy polyethoxy)phenyl]propane, 2,2-bis[4-(methacryloxy polyethoxy)phenyl]propane and 2-hydroxy-1-acryloxy-3-methacryloxypropane; polyester compounds of (meth)acrylic acid and a compound having three or more hydroxyl groups in its molecule, such as trimethylolpropane tri(meth)acrylate, tetramethylolmethane tri(meth)acrylate, tetramethylolmethane tetra(meth)acrylate, pentaerythritol tetrakis(meth)acrylate or dipentaerythritol hexakis(meth)acrylate; allyl(meth)acrylate; divinylbenzene; and the like, and the present invention is not limited only to those exemplified ones. These polyfunctional monomers can be used alone or in combination of at least two kinds.

The mass ratio of the polyfunctional monomer to the polyvalent mercaptan compound (mass of the polyfunctional monomer/mass of the polyvalent mercaptan) is preferably 2/1 or less, more preferably 0.05/1 to 2/1, further preferably 0.05/1 to 1.5/1, and furthermore preferably 0.05/1 to 1/1 from the viewpoint of inhibition of gelation of the sulfur bond-containing (meth)acrylic adhesive resin.

In addition, the mass ratio of the polyfunctional monomer to the raw material monomer (mass of polyfunctional monomer/mass of raw material monomer) is preferably 0.05/1 or less, more preferably 0.001/1 to 0.05/1, further preferably 0.001/1 to 0.03/1, and furthermore preferably 0.001/1 to 0.01/1 from the viewpoint of inhibition of gelation of the sulfur bond-containing (meth)acrylic adhesive resin.

When the raw material monomer is polymerized in the presence of a polyvalent mercaptan compound, at least three chain polymers are bonded to the mercapto group of the polyvalent mercaptan compound. In this case, a part of the mercapto groups of the polyvalent mercaptan compound remains. Therefore, when the raw material monomer is further added to this reaction system, and the radical polymerization of the raw material monomer is carried out, a resulting polymer is bonded to the mercapto group remaining in the polyvalent mercaptan compound, and thereby a sulfur bond-containing (meth)acrylic adhesive resin is obtained. Incidentally, when the raw material monomer is further added to the reaction system, and the radical polymerization of the raw material monomer is carried out, it is preferable to add a polymerization initiator later.

As a suitable method for preparing a sulfur bond-containing adhesive (meth)acrylic resin, there can be cited a method which includes polymerizing a part of the raw material monomer in the presence of a polyvalent mercaptan compound, and polymerizing a polymer included in the resulting polymer solution, the remaining of the raw material monomer and a polyfunctional monomer.

When a part of the raw material monomer is polymerized in the presence of a polyvalent mercaptan compound, the reaction temperature is usually preferably 30 to 200° C., and more preferably 50 to 150° C. Incidentally, when the raw material monomer is polymerized, it is preferable to terminate the polymerization reaction at the stage of the rate of polymerization of preferably 50 to 90%, more preferably 55 to 85%, and further preferably 60 to 80%.

The termination of the polymerization reaction can be carried out by a method which includes lowering the temperature of the resulting polymer solution, a method which includes adding a polymerization inhibitor to the polymer solution, and the like.

When the polymerization reaction is terminated by lowering the temperature of the polymer solution, the temperature of the polymer solution is preferably 40° C. or less, and more preferably 20° C. or less from the viewpoint of sufficient termination of the polymerization reaction.

When the polymerization reaction is terminated by adding a polymerization inhibitor to the polymer solution, the polymerization inhibitor includes, for example, phenol compounds such as hydroquinone, 2,5-bis(1,1,3,3-tetramethylbutyl)hydroquinone, 2,5-bis(1,1-dimethylbutyl)hydroquinone, methoxyphenol, 6-tertiary-butyl-2,4-xylenol and 3,5-ditertiary-butyl catechol; N-nitrosophenylhydroxylamine aluminum salt; phenothiazine; and the like, and the present invention is not limited only to those exemplified ones. These polymerization inhibitors can be used alone or in combination of at least two kinds.

The amount of the polymerization inhibitor is preferably 0.0001 to 1 part by mass, more preferably 0.001 to 0.1 parts by mass, and further preferably 0.002 to 0.02 parts by mass per 100 parts by mass of the raw material monomer.

Next, the polymer contained in the polymer solution, the remaining of the raw material monomer and a polyfunctional monomer are polymerized, and thereby a sulfur bond-containing (meth)acrylic adhesive resin can be obtained.

Incidentally, a method for polymerizing the polymer contained in the polymer solution, the remaining of the raw material monomer and a polyfunctional monomer can be performed in accordance with the above-mentioned polymerization method of the monomer component, which is used in the preparation of the above-mentioned acrylic adhesive resin.

A sulfur bond-containing (meth)acrylic adhesive resin thus obtained has a weight average molecular weight of preferably 200000 to 600000 or so from the viewpoint of having the adhesive layer formed on the medical adhesive sheet a viscosity appropriate for the medical adhesive sheet.

It is preferable that the adhesive resin has adhesion at ambient temperature. It is preferable that the glass transition temperature of the adhesive resin is from −65 to −30° C. from the viewpoint of having the adhesive resin adhesion suitable for the medical adhesive sheet. The glass transition temperature of the adhesive resin can be controlled by adjusting the monomer composition used as a raw material in the preparation of the adhesive resin. The glass transition temperature of the adhesive resin can be determined by using a differential scanning calorimeter (DTC), a differential thermal analyzer (DTA), a thermomechanical analyzer (TMA) or the like. In addition, the glass transition temperature of the adhesive resin can also be determined by using a glass transition temperature of a homopolymer made of a monomer used as a raw material in the preparation of the adhesive resin in accordance with the Fox equation represented by the equation:

1/Tg=Σ(Wm/Tgm)/100

wherein Wm is a content (% by weight) of a monomer “m” in the monomer component used for preparing a polymer, and Tgm is a glass transition temperature (absolute temperature: K) of a homopolymer made of the monomer “m”.

Incidentally, when the adhesive resin has a crosslinkable group (functional group), a crosslinking agent can be contained in the adhesive agent as occasion demands. The adhesive resin having a crosslinkable group can be cured by crosslinking the adhesive resin with the crosslinking agent.

As a crosslinking agent, there can be used a compound having two or more functional groups in its molecule, which can react with the crosslinkable group of the adhesive resin. The crosslinking agent includes, for example, a polyisocyanate crosslinking agent, a polyfunctional epoxy crosslinking agent, a silicone crosslinking agent and the like, and the present invention is not limited only to those exemplified ones.

The polyisocyanate crosslinking agent includes, for example, aromatic polyisocyanates such as xylylene diisocyanate, diphenylmethane diisocyanate, triphenylmethane triisocyanate and tolylene diisocyanate; aliphatic or alicyclic polyisocyanates such as hexamethylene diisocyanate, isophorone diisocyanate and hydrogenated products of the above-mentioned aromatic polyisocyanates; dimers or trimers of these polyisocyanates; adducts of these polyisocyanates and polyols such as trimethylolpropane; and the like, and the present invention is not limited only to those exemplified ones. These polyisocyanate crosslinking agents can be used alone or in combination of at least two kinds.

The polyisocyanates are easily commercially available, for example, under the trade name of “Coronate L”, “Coronate L-55E”, “Coronate HX”, “Coronate HL”, “Coronate HL-S”, “Coronate 2234”, “Aquanate 200” and “Aquanate 210” (produced by Nippon Polyurethane Industry Co., Ltd.; each of “Coronate” and “Aquanate” is a registered trademark); “Desmodur N3400” (Sumitomo Beyer Urethane Co., Ltd. (now Beyer A.G.); “Desmodur” is a registered trademark); “Duranate D-201”, “Duranate TSE-100”, “Duranate TSS-100”, “Duranate 24A-100” and “Duranate E-405-80 T” (produced by Asahi Kasei Chemicals Corp.; “Duranate” is a registered trademark); “Takenate D-110 N”, “Takenate D-120N”, “Takenate M-631 N” and “MTERT-Olester NP1200” (produced by Mitsui Chemicals Polyurethane Co., Ltd.; each of “Takenate” and “Olester” is a registered trademark); and the like. These polyisocyanates can be used alone or in combination of at least two kinds.

The polyfunctional epoxy crosslinking agent includes, for example, ethylene glycol diglycidyl ether, polyethylene glycol diglycidyl ether, 1,6-hexanediol diglycidyl ether, bisphenol A type epoxy resin, N,N,N′,N′-tetraglycidyl-m-xylenediamine, 1,3-bis(N, N-diglycidylaminomethyl)cyclohexane, N,N-diglycidylaniline, N,N-diglycidyltoluidine and the like, and the present invention is not limited only to those exemplified ones. These polyfunctional epoxy crosslinking agents can be used alone or in combination of at least two kinds.

The silicone crosslinking agent includes, for example, a product number: X-92-122 produced by Shin-Etsu Chemical Co., Ltd., and the like, and the present invention is not limited only to the exemplified one. The silicone crosslinking agents can be used alone or in combination of at least two kinds.

Among the crosslinking agents, a polyisocyanate dimer, a polyisocyanate trimer, a bifunctional prepolymer of a polyisocyanate, an adduct of a polyisocyanate, and the like are preferable; a dimer of hexamethylene diisocyanate, an isocyanurate (trimer) of hexamethylene diisocyanate, an adduct of tolylene diisocyanate and trimethylolpropane, and the like are more preferable; and an isocyanurate of hexamethylene diisocyanate is further preferable. As the isocyanurate of hexamethylene diisocyanate, there can be cited, for example, Duranate (registered trademark) TSE-100 and Duranate (registered trademark) TSS-100, which are trade names produced by Asahi Kasei Chemicals Corp., and the like, and the present invention is not limited only to those exemplified ones.

The amount of the crosslinking agent is usually preferably 0.1 to 2 equivalents, and more preferably 0.3 to 1.5 equivalents when the total amount of the crosslinkable groups (functional groups) of the adhesive resin is 1 equivalent.

In addition, a crosslinking accelerator can be used in a proper amount in the present invention. The crosslinking accelerator includes, for example, dibutyltin dilaurate, tin octoate, dibutyltin di(2-ethylhexanoate), lead 2-ethylhexanoate, 2-ethylhexyl titanate, iron 2-ethylhexanoate, cobalt 2-ethylhexanoate, zinc naphthenate, cobalt naphthenate, tin octanoate, bismuth octanoate, tetra-n-butyltin, diisopropoxytitanium bis(ethylacetoacetate), zirconium tetra acetylacetonate and the like, and the present invention is not limited only to those exemplified ones. These crosslinking accelerators can be used alone or in combination of at least two kinds.

It is preferable that the adhesive resin is used as an adhesive resin solution by dissolving the adhesive resin in an organic solvent. The organic solvent used in the adhesive resin solution is not particularly limited as long as the organic solvent can dissolve the adhesive resin. The organic solvent includes, for example, gasoline, coal tar naphtha, petroleum ether, petroleum benzine, terebic acid, mineral spirit and the like, as well as the organic solvent used in the polymerization of the monomer component by a solution polymerization method, and the present invention is not limited only to those exemplified ones. The concentration of a non-volatile component in the adhesive resin solution is not particularly limited, and is usually 10 to 70% by mass or so.

The content of the adhesive resin in the adhesive is adjusted so that the total amount of a crosslinking agent, a crosslinking accelerator, a below-described antibacterial agent, a below-described additive and the like when being used is 100% by mass. The content of the adhesive resin in the adhesive is preferably 10% by mass or more, and more preferably 15% by mass or more from the viewpoint of improvement in adhesion property, and is preferably 90% by mass or less, and more preferably 85% by mass or less from the viewpoint of improvement in coating properties.

When antibacterial property is required for the adhesive, it is preferable that an antibacterial agent is contained in the adhesive. As a preferred antibacterial agent, there can be cited, for example, a methyl-cyclodextrin iodine inclusion complex and the like, and the present invention is not limited only to those exemplified ones. The methyl-cyclodextrin iodine inclusion complex includes, for example, methyl-α-cyclodextrin, methyl-β-cyclodextrin, methyl-γ-cyclodextrin and the like, and the present invention is not limited only to those exemplified ones. These methyl-cyclodextrin iodine inclusion complexes can be used alone or in combination of at least two kinds. Among these methyl-cyclodextrin iodine inclusion complexes, methyl-β-cyclodextrin is preferred because of its excellent solubility in an organic solvent.

The amount of the antibacterial agent cannot be absolutely determined because the antibacterial property varies depending on its kind, and the amount of the antibacterial agent is usually preferably 0.01 to 20 parts by mass, more preferably 1 to 18 parts by mass, and further preferably 5 to 15 parts by mass per 100 parts by mass of the non-volatile components of the adhesive from the viewpoint of imparting antibacterial properties and the viewpoint of increase in economic efficiency.

In addition, in the adhesive, additives such as a dispersant, a tackifier, an antioxidant, a plasticizer, a fire retardant, a fire-retardant aid, an anti-settling agent, a thickener, a thixotropy-imparting agent, a surfactant, an antifoaming agent, an antistatic agent, a surface-treating agent, an anti-aging agent, an ultraviolet absorber and an ultraviolet stabilizer can be contained in a proper amount within the scope which would not hinder an object of the present invention as occasion demands.

The adhesive can be easily prepared by mixing the adhesive resin, a crosslinking agent, a crosslinking accelerator, an antibacterial agent, an additive, and the like.

The content of the non-volatile components in the adhesive is preferably 20% by mass or more, and more preferably 30% by mass or more from the viewpoint of improvement in productivity, and is preferably 80% by mass or less, and more preferably 70% by mass or less from the viewpoint of improvement in coating property. The content of the non-volatile components in the adhesive can be controlled by adjusting the amount of a solvent, an additive and the like, which are contained in the adhesive. The above-mentioned solvent can be the same as the organic solvent used in the adhesive resin solution.

The viscosity of the adhesive when determined by a TVB-10M viscometer produced by Toki Sangyo Co., Ltd. at a rotational speed of 12 rpm at a temperature of 25° C. is preferably 100 mPa·s or more, more preferably 500 mPa·s or more, and further preferably 1000 mPa·s or more from the viewpoint of improvement in coating property, and is preferably 60000 mPa·s or less, more preferably 40000 mPa·s or less, and further preferably 20000 mPa·s or less from the viewpoint of improvement in coating property as described in the above.

An adhesive layer can be formed by applying the adhesive to a resin film, or by applying the adhesive to a release liner and thereafter transferring the formed adhesive layer to a resin film. The latter method is advantageous in that a heat history is not imparted to the resin film when the adhesive layer is dried.

A method for applying the adhesive includes, for example, a coating method in which a knife coater, a slot-die coater, a lip coater, a roll coater, a flow coater, a spray coater, a bar coater, a comma coater, a doctor blade or the like is used, a coating method such as dipping, and the like, and the present invention is not limited only to those exemplified ones.

The adhesive can be applied so that an adhesive layer is not formed at the end of the resin film. The portion where an adhesive layer is not formed can be used as a portion for holding with fingers when an adhesive sheet is attached to an adhered, which is a so-called dry edge.

The coating amount of the adhesive is preferably 5 g/m² or more, and more preferably 10 g/m² or more from the viewpoint of exertion of sufficient adhesion, and is preferably 100 g/m² or less, and more preferably 80 g/m² or less from the viewpoint of improvement in flexibility of an adhesive sheet.

After the application of the adhesive, an adhesive layer can be formed by drying the adhesive. As a means for drying the adhesive, there can be cited, for example, hot air, far-infrared irradiation, and the like. The thickness of the adhesive layer after drying the adhesive is not particularly limited, and is usually 10 to 1000 μm or so.

A release liner is attached to the surface of the adhesive layer formed on the resin film. When the release liner is thus attached to the surface of the adhesive layer, the adhesive layer can be protected. When the adhesive is used, the release liner is peeled from the surface of the adhesive layer.

The release liner includes, for example, a resin film of a polyolefin such as polyethylene or polypropylene, a resin film of a polyester such as polyethylene terephthalate, a resin film of polystyrene, glassine paper, and the like, and the present invention is not limited only to those exemplified ones. Incidentally, when the resin film is used as a release liner, a resin treatment can be applied to the resin film with a silicone resin, a fluorocarbon resin, and the like.

It is preferred that the size and the shape of the release liner are usually adjusted so that the size and the shape correspond to those of the adhesive layer formed on the resin film.

The medical adhesive sheet is obtained as described in the above. When the obtained medical adhesive sheet is long, the sheet can be wound around, for example, a winding core. A sterilization treatment can be applied to the medical adhesive sheet with, for example, radioactive ray such as gamma ray, or electron beam as occasion demands. The obtained medical adhesive sheet can be cut so as to have a length suitable for its uses as occasion demands.

Next, the medical adhesive sheet is folded so that the face of the release liner forms an inner surface, and the face of the resin film forms an outer surface.

One of great characteristics of the present invention resides in that the medical adhesive sheet is folded as mentioned above. Since the medical adhesive sheet is folded so that the face of the release liner forms an inner surface, and the face of the resin film forms an outer surface in the present invention, the resin film is always mountain-folded. Therefore, tension is applied to the resin film, and the medical adhesive sheet has no creases which are formed when the resin film is valley-folded. Accordingly, since the uniformity of the adhesive layer formed on the resin film is maintained in the thickness direction, quality of the medical adhesive sheet can be improved.

A method for folding the medical adhesive sheet so as to form the face of the release liner as an inner surface, and the face of the resin film as an outer surface includes, for example, a method which includes winding the medical adhesive sheet so that the face of the resin film forms an outer surface, thereafter pressing the wound medical adhesive sheet in its diameter direction to make the medical adhesive sheet flat in the diameter direction, and the like, and the present invention is not limited only to the exemplified method. The medical adhesive sheet which is thus folded by winding the medical adhesive sheet so that the face of the resin film forms an outer surface has some advantages such that the medical adhesive sheet can be compactly and easily accommodated between packaging sheets, and that the uniformity of the adhesive layer formed on the resin film can be maintained in its thickness direction.

Incidentally, when the medical adhesive sheet is wound so that the face of the resin film forms an outer surface, it is preferable to wind the medical adhesive sheet into a cylindrical shape so that a space is formed at the central portion of the winding from the viewpoint of evenly folding the medical adhesive sheet. The inner diameter of the cylinder formed by winding the medical adhesive sheet is not particularly limited, and is usually preferably 30 to 100 mm or so from the viewpoint of miniaturization of the width of the folded medical adhesive sheet and flattening of the cylinder. In addition, the number for winding the medical adhesive sheet cannot be absolutely determined because the number varies depending on the length of the medical adhesive sheet, the inner diameter of the cylinder and the like, and is usually preferably 1 to 10 times or so from the viewpoint of miniaturization of the width of the folded medical adhesive sheet and flattening of the cylinder.

Next, the folded medical adhesive sheet is put between packaging sheets. The packaging sheets are sealed at the periphery of the packing sheets, and thereby the packaging body of a medical adhesive sheet of the present invention is obtained.

In the present invention, there is another characteristic in that the folded medical adhesive sheet is put between packaging sheets as described above. Since the folded medical adhesive sheet is put between packaging sheets in the present invention, the packaging body can eliminate a defect such that the end of the medical adhesive sheet is caught at the end of the opening of the packaging body, and that the resin film is peeled from the medical adhesive sheet when the medical adhesive sheet is inserted into a packaging body, which has been caused in conventional medical adhesive sheets.

The packaging sheet includes, for example, a resin sheet made of a polyolefin resin such as a polyethylene resin or a polypropylene resin, a polybutadiene resin, a polystyrene resin, acrylonitrile-styrene copolymer, acrylonitrile-butadiene-styrene copolymer, a polyvinyl chloride resin, a polyvinylidene chloride resin, a fluorocarbon resin, ethylene-vinyl alcohol copolymer, a poly(meth)acrylic resin, a polycarbonate resin, a polyester resin such as polyethylene terephthalate, polybutylene terephthalate or polyethylene naphthalate, a polyamide resin such as Nylon 66; a polyaryl phthalate resin, a polyurethane resin, a cellulose resin, or the like, and the present invention is not limited only to those exemplified ones. These resin sheets can be unstretched, or uniaxially or biaxially stretched, and an unstretched sheet is preferable from the viewpoint of imparting flexibility to the resin sheet. Among these resin sheets, a polyolefin resin sheet, a polystyrene resin sheet, a polyester resin sheet and the like are preferable from the viewpoint of easiness in heat-sealing of a packaging sheet.

The thickness of the packaging sheet is not particularly limited, and is preferably 0.5 μm or more, and more preferably 1.0 μm or more from the viewpoint of increase in mechanical strength, and is preferably 80 μm or less, more preferably 60 μm or less, and further preferably 50 μm or less from the viewpoint of improvement in flexibility.

Incidentally, the packaging sheet can be laminated with, for example, a metal foil made of a metal such as aluminum. Alternatively, a metal film made of a metal such as aluminum can be formed on the packaging sheet. When the packaging sheet is laminated with a metal foil, or when a metal film is formed on the packaging sheet as mentioned above, light blocking properties and gas barrier properties can be imparted to the packaging sheet. When the packaging sheet is laminated with a metal foil, the metal foil can be bonded to the packaging sheet by using, for example, an adhesive agent and the like. In addition, when a metal film is formed on the packaging sheet, the metal film can be formed on the packaging sheet, for example, by means of chemical vapor deposition (CVD) and the like. The metal foil and the metal film can be formed on only one surface or both surfaces of the packaging sheet. Alternatively, the metal foil and the metal film can be laminated between two packaging sheets.

The size of the packaging sheet cannot be absolutely determined because the size differs depending on the size of the folded medical adhesive sheet to be accommodated in a packaging body. Accordingly, it is preferable to determine the size of the packaging sheet so that the folded medical adhesive sheet is accommodated in the packaging body. The size of the packaging sheet is usually preferably larger than the size of the folded medical adhesive sheet so that the folded medical adhesive sheet can be accommodated in the packaging body. In addition, when the periphery of the packaging sheet is heat-sealed, it is preferable that the packaging sheet has a margin for heat-sealing.

When the folded medical adhesive sheet is put between packaging sheets, one packaging sheet is folded in half, and the folded medical adhesive sheet is put between the folded packaging sheet. Alternatively, two packaging sheets are prepared, and the folded medical adhesive sheet is put between the two packaging sheets.

A method for putting the folded medical adhesive sheet between packaging sheets, and sealing the periphery of the packaging sheets includes, for example, a method which includes superposing packaging sheets, and heat-sealing the superposed portion by means of a heat sealer or the like, and the like, and the present invention is not limited only to the exemplified method. Incidentally, when the periphery of packaging sheets is sealed, degassing can be carried out between the packaging sheets so that air does not enter the inside of the packaging body being formed. Alternatively, an inert gas such as nitrogen gas or carbon dioxide gas can be enclosed in the packaging body.

The packaging body of the medical adhesive sheet of the present invention is thus obtained. The packaging body of a medical adhesive sheet of the present invention can be sterilized as occasion demands. The method for sterilizing the packaging body of a medical adhesive sheet includes, for example, a treating method for sterilization such as irradiation sterilization or heat sterilization, and the like, and the present invention is not limited only to those exemplified ones. Among these methods for sterilizing, irradiation sterilization, in particular sterilization by irradiation with radioactive ray such as gamma ray or electron beam is preferable because the packaging body is not exposed to a high temperature.

Since the packaging body of a medical adhesive sheet of the present invention has the above-mentioned constituents, the packaging body has excellent qualities, such that the packaging body does not necessitate a packaging paper for packaging an incise drape, that the packaging body has no creases on the film which constitutes an incise drape, and that the packaging body has no exfoliation of a film at its end.

### EXAMPLES

Next, the present invention is more specifically described based on working examples. However, the present invention is not limited only to those working examples.

Incidentally, in the following examples and comparative examples, the term “adhesive sheet” means a film which is produced by cutting an adhesive film on a flat plate; and the term “adhesive film” means a resin film on which an adhesive layer is formed. In addition, the term “adhesive film roll” means a roll of the “adhesive film” (one having a roll-like shape).

### Producing Example 1

A four-necked flask equipped with a thermometer, a stirrer, an inert-gas introducing pipe, a reflux condenser and a dropping funnel was charged with 24 parts (parts by mass; hereinafter referred to the same) of methyl methacrylate, 1.2 parts of dipentaerythritol-6-mercaptopropionate and 24.82 parts of ethyl acetate as a solvent. While stirring the resulting mixture under nitrogen gas flow and maintaining the internal temperature of the flask to 83±2° C., 0.048 parts of dimethyl-2,2′-azobis-2-methyl propionate as a polymerization initiator and 0.432 parts of ethyl acetate were added to the flask to initiate the polymerization.

After 30 minutes passed from the initiation of the polymerization reaction, 56 parts of methyl methacrylate and 15.25 parts of ethyl acetate were added dropwise to the flask over 120 minutes, and a mixture of 0.084 parts of dimethyl-2,2′-azobis-2-methyl propionate, 2.8 parts of dipentaerythritol-β-mercaptopropionate and 2.8 parts of ethyl acetate was added dropwise to the flask over 90 minutes. The reaction was carried out while controlling the internal temperature of the flask under reflux.

After the completion of the dropwise addition of methyl methacrylate, 2 parts of ethyl acetate was added to the flask, and the reaction was further carried out for 130 minutes. Subsequently, a mixture of 0.04 parts of hydroquinone monomethyl ether as a polymerization inhibitor and 0.36 parts of ethyl acetate and 38.431 parts of ethyl acetate was added to the flask, and cooled, to obtain a polymer solution A. The non-volatile content in the obtained polymer solution A was 34.5%, and the viscosity thereof (as determined by means of a Brookfield viscometer at a rotational speed of 12 rpm, hereinafter referred to the same) was 90 mPa·s at 25° C.

A four-necked flask equipped with a thermometer, a stirrer, an inert-gas introducing pipe, a reflux condenser and a dropping funnel was charged with 60.9 parts of the polymer solution A, 34.46 parts of butyl acrylate, 136.02 parts of 2-ethylhexyl acrylate, 8.98 parts of acrylic acid, 0.09 parts of tetraethylene glycol diacrylate (commercially available from Shin-Nakamura Chemical Co., Ltd. under the trade name of NK Ester A-200) and 170 parts of ethyl acetate as a solvent. The content in the flask was stirred under nitrogen gas flow, and a mixture of 0.336 parts of dimethyl-2,2′-azobis-2-methyl propionate as a polymerization initiator and 10 parts of ethyl acetate was added to the flask while the internal temperature of the flask was maintained at 86±2° C., to initiate the polymerization reaction.

After 10 minutes passed from the initiation of the polymerization reaction, 142.1 parts of the above-mentioned polymer solution, a monomer mixture of 220.8 parts of butyl acrylate, 163.23 parts of 2-ethylhexyl acrylate, 20.95 parts of acrylic acid, 13.77 parts of vinyl acetate, 0.21 parts of tetraethylene glycol diacrylate (commercially available from Shin-Nakamura Chemical Co., Ltd. under the trade name of NK Ester A-200) and 176 parts of ethyl acetate, and a mixture of 0.784 parts of dimethyl-2,2′-azobis-2-methyl propionate and 40 parts of ethyl acetate were added dropwise to the flask over 80 minutes, and the reaction was carried out under reflux.

Next, 10 parts of ethyl acetate was added to the flask, and the reaction was further carried out for 60 minutes. Thereafter, a mixture of 13.36 parts of dimethyl-2,2′-azobis-2-methyl propionate and 40 parts of ethyl acetate was divided into 12 portions, and every portion was added dropwise to the flask for every 30 minutes. The reaction was further continued for 120 minutes under reflux. Thereafter, 100 parts of ethyl acetate was added as a diluting solvent to the flask, and cooled, to obtain a polymer solution B. The non-volatile content in the obtained polymer solution B was 52.2%, the viscosity thereof was 6170 mPa·s at 25° C., and the weight average molecular weight of the polymer was 259000.

Next, the polymer solution B was mixed with terpene phenolic resin (commercially available from Yasuhara Chemical Co., Ltd. under the trade name of YS Polyster T100) in a ratio of 10 parts of terpene phenolic resin to 100 parts of the non-volatile content of the polymer solution B, and the viscosity of the mixture was adjusted with ethyl acetate, to obtain an adhesive. The non-volatile content of the obtained adhesive was 52.2%, and the viscosity thereof was 5120 mPa·s at 25° C.

### Producing Example 2

The adhesive obtained in Producing Example 1 was sufficiently mixed with a 40% methyl alcohol solution of methylated 6-cyclodextrin iodine inclusion complex [commercially available from Nippoh Chemicals Co., Ltd. under the trade name of MCDI, effective concentration of iodine: about 13% (% by mass, hereinafter referred to the same)] in a ratio of 15 parts of methylated β-cyclodextrin iodine inclusion complex to 100 parts of the non-volatile content of the adhesive, to obtain a mixture.

To the mixture obtained in the above was slowly added isopropyl myristate in a ratio of 15 parts of isopropyl myristate to 100 parts of the non-volatile content of the mixture, and sufficiently stirred, to obtain an adhesive solution. The obtained adhesive solution was filtered with a cartridge filter (pore diameter: 25 μm) prior to using.

### Example 1

A release liner (commercially available from Sumika-Kakoushi Co., Ltd. under the trade name of Sumilease middle-release type) was placed in a large scale line coater equipped with five drying ovens. The adhesive solution obtained in Producing Example 2 was applied to one side surface of the release liner so as to have a thickness of 45 μm, and dried on the line. When the release liner appeared from the drying ovens, a polyethylene film (low-density-polyethylene, thickness: 35 μm) was laid on the adhesive surface of the release liner, and then the release liner was wound, to obtain an adhesive film roll in which an adhesive film having a length of about 1000 m was wound.

Incidentally, the separation load of the release liner used in the above was determined. As a result, the separation load was 70 N/m. In the present specification, the separation load of the release liner is a value as determined in accordance with the following method:

[Method for Measuring Separation Load of Release Liner]

An adhesive (commercially available from Toyo Ink Mfg. Co., Ltd. under the trade name of Oribain BPS-8170) was applied to a release liner so as to have a thickness of 30 μm, and then a high-quality paper (basis weight: 78 g/m²) was attached to the coated surface. Thereafter, the separation load was measured when the high-quality paper was separated from the release liner at ambient temperature (about 23° C.) at a separating speed of 5 m/min and at a separating angle of 180°.

The adhesive film roll obtained in the above was allowed to age at room temperature for one week, and placed in a slitting machine. As a result, a separation (tunneling phenomenon) of the adhesive film was slightly observed up to the distance of 1 m or so from the starting point of the roll, and no separation of the adhesive film was observed after that. Thereafter, the adhesive film in length of 250 m was wounded as one roll.

Next, the adhesive film was cut into pieces having a length of 45 cm, and then each piece was wound around a pipe made of a vinyl chloride resin having a diameter of 6 cm so that the polyethylene film was formed outside in the vertical direction (VD) with respect to the machine direction (MD), to obtain a cylindrical body of the adhesive sheet. Thereafter, the pipe made of a vinyl chloride resin was taken out from the cylindrical body, and the cylindrical body was put between two resin plates placed in parallel. The cylindrical body was pressed so that the cylindrical body became flat, to impart fold lines to the cylindrical body. Thus, a folded adhesive sheet was obtained.

Next, a packaging sheet made of an aluminum-laminated resin film [a laminated film of a polyethylene terephthalate film (thickness: 12 μm), aluminum foil (thickness: 9 μm) and an unstretched polypropylene film (thickness: 35 μm)] coated with a hot-melt adhesive was folded in half, and the folded adhesive sheet was put between the folded packaging sheet made of the aluminum-laminated resin film. The ends of the folded packaging sheet were superimposed, and the adhesive sheet was sealed by heat-sealing the superimposed ends with a heat sealer so that air was not entered into a packaging body, to obtain a packaging body of the adhesive sheet. The obtained packaging body of the adhesive sheet was sterilized by electron beam irradiation (exposure dose: 45 kGy).

### Example 2

A four-necked flask equipped with a thermometer, a stirrer, an inert-gas introducing pipe, a reflux condenser and a dropping funnel was charged with 90 parts of 2-ethylhexyl acrylate, 10 parts of acrylic acid and 62 parts of ethyl acetate as a solvent. The content in the flask was stirred under nitrogen gas flow, and a mixture of 0.05 parts of dimethyl-2,2′-azobis-2-methyl propionate as a polymerization initiator and 4.95 parts of ethyl acetate was added to the flask while the internal temperature of the flask was maintained at 60±2° C., to initiate the polymerization reaction.

After 4 hours passed from the initiation of the polymerization reaction, 233 parts of ethyl acetate was divided into some portions, and every portion was added to the flask. The polymerization reaction was carried out for 10 hours, to obtain a polymer solution. The non-volatile content of the obtained polymer solution was 21.0%; the viscosity of the polymer solution was 13200 mPa·s at 25° C.; and the weight average molecular weight of the polymer was 1610000.

Next, the polymer solution was mixed with a terpene phenolic resin (commercially available from Yasuhara Chemical Co., Ltd. under the trade name of YS Polyster T100) in a ratio of 10 parts of the terpene phenolic resin to 100 parts of the non-volatile content of the polymer solution. The viscosity of the resulting mixture was adjusted with ethyl acetate, to obtain an adhesive. The non-volatile content of the obtained adhesive was 22.2%, and the viscosity of the adhesive was 8190 mPa·s at 25° C.

The adhesive obtained in the above was sufficiently mixed with a 40% methyl alcohol solution of methylated β-cyclodextrin iodine inclusion complex [commercially available from Nippoh Chemicals Co., Ltd. under the trade name of MCDI, concentration of effective iodine: about 13% (% by mass; hereinafter the same)] in a ratio of 15 parts of methylated β-cyclodextrin iodine inclusion complex to 100 parts of the adhesive, to obtain a mixture.

To the mixture obtained in the above was slowly added isopropyl myristate in a ratio of 15 parts of isopropyl myristate to 100 parts of the non-volatile content of the mixture, and sufficiently stirred, to obtain an adhesive solution. The obtained adhesive solution was filtered with a cartridge filter (pore diameter: 25 μm) prior to using.

Next, a packaging body of an adhesive sheet was prepared by using the adhesive solution obtained in the above in the same manner as in Example 1, and the obtained packaging body of the adhesive sheet was sterilized by electron beam irradiation (exposure dose: 45 kGy).

### Comparative Example 1

In the same manner as in Example 1, the adhesive film was cut into pieces having a length of 45 cm and each piece was wound around a pipe made of a vinyl chloride resin having a diameter of 4 cm so that the polyethylene film was formed outside in the vertical direction (VD) with respect to the machine direction (MD), to obtain a cylindrical body of the adhesive sheet. Thereafter, the pipe made of a vinyl chloride resin was taken out from the cylindrical body, and the cylindrical body was put between two resin plates placed in parallel. The cylindrical body was pressed so that the cylindrical body became flat, to impart fold lines to the cylindrical body. Thus, a folded adhesive sheet was obtained.

Next, the folded adhesive sheet obtained in the above was inserted into a bag having an opening, which was produced by folding in half an aluminum-laminated resin film coated with a hot-melt adhesive, superposing the ends of the resin film, and heat-sealing two of the superposed three ends by means of a heat sealer. Thereafter, the opening of the bag was sealed by heat-sealing with a heat sealer so that air was not entered into the bag, to obtain a packaging body of the adhesive sheet. Subsequently, the obtained packaging body of the adhesive sheet was sterilized by electron beam irradiation (exposure dose: 45 kGy).

### Comparative Example 2

A folded adhesive sheet was obtained in the same manner as in Example 1. The folded adhesive sheet was tried to be put into a bag in the same manner as in Comparative Example 1. However, since the end of the adhesive sheet was turned up at the entrance of the bag, a packaging body could not be produced.

### Comparative Example 3

A folded adhesive sheet was obtained in the same manner as in Example 1. According to Comparative Example 2, since the end of the adhesive sheet was turned up at the entrance of the bag, a high-quality paper (basis weight: 78 g/m²) was folded in half, and the folded adhesive sheet was put between the folded high-quality paper. Thereafter, the adhesive sheet covered with the high-quality paper was put into a bag in the same manner as in Comparative Example 1, and the bag was sealed by heat-sealing the opening of the bag by means of a heat sealer so that air did not enter into the bag, to obtain a packaging body of the adhesive sheet. Subsequently, the obtained packaging body of the adhesive sheet was sterilized by electron beam irradiation (exposure dose: 45 kGy).

Next, the performance evaluation of the packaging bodies of the adhesive sheet obtained in each Example and each Comparative Example was examined in accordance with the following methods. The results are shown in Table 1.

(1) Appearance of Adhesive Sheet

The packaging body of the adhesive sheet was opened, and the adhesive sheet was taken out from the packaging body. The folded portion of the adhesive sheet was visually observed and evaluated in accordance with the following evaluation criteria:

### [Evaluation Criteria]

∘: No defect in the folded portion of the adhesive sheet
x: Existing concave and convex portions at the folded portion of the adhesive sheet (Failure)

(2) Easiness for Producing Packaging Body

When a packaging body of an adhesive sheet was produced, it was examined whether or not the packaging body could be easily produced, and the easiness was evaluated in accordance with the following evaluation criteria:

### [Evaluation Criteria]

∘: A packaging body could be produced without any problems.
x: A packaging body could not be produced (Failure).

(3) Turn-Up of End

When a packaging body of an adhesive sheet was produced, it was examined whether or not the end of the packaging body was easily turned up, and the turn-up was evaluated in accordance with the following evaluation criteria:

### [Evaluation Criteria]

∘: The end of the packaging body was not easily turned up.
x: The end of the packaging body was easily turned up (Failure).

(4) Presence of Waste

It was confirmed whether or not there was waste other than the bag and the release liner used in the packaging body of the adhesive sheet, and the presence of waste was evaluated in accordance with the following evaluation criteria:

### [Evaluation Criteria]

∘: No waste was observed.
x: Presence of waste was observed (Failure).

TABLE 1

| | Evaluation of performance of | | | |
|---|---|---|---|---|
| | packaging body of adhesive sheet | | | |
| Example and | Appearance of | Easiness for | Turn- | Presence |
| Comparative | Adhesive | Producing | up of | of |
| Example No. | Sheet | Packaging body | End | Waste |
| Ex. 1 | ◯ | ◯ | ◯ | ◯ |
| Ex. 2 | ◯ | ◯ | ◯ | ◯ |
| Comp. Ex. 1 | X | ◯ | ◯ | ◯ |
| Comp. Ex. 2 | ◯ | X | X | ◯ |
| Comp. Ex. 3 | ◯ | ◯ | ◯ | X |

As is clear from the results shown in Table 1, since the packaging bodies of an adhesive sheet obtained in the Examples are easily produced, have no turn-up of the ends of the adhesive sheets and no presence of waste other than the bags and the release liners, and are excellent in appearance of an adhesive sheet in comparison with the packaging bodies of an adhesive sheet obtained in Comparative Examples, it can be seen that the packaging body obtained in each Example has excellent qualities such that the packaging body does not necessitate a packaging paper for packaging an incise drape, that a film which constitutes an incise drape has no creases, and that the film is not peeled off at its end.

### INDUSTRIAL APPLICABILITY

The packaging body of the medical adhesive sheet of the present invention is expected to be used for uses such as an incise drape which is used in surgery.

1. A packaging body of a medical adhesive sheet, in which the medical adhesive sheet is included, wherein the medical adhesive sheet comprises a resin film having an adhesive layer to which a release liner is attached; wherein said medical adhesive sheet is folded so that the face of the release liner forms an inner surface, and the face of the resin film forms an outer surface; and wherein the folded medical adhesive sheet is put between sheets for packaging, and the periphery of the sheets for packaging is sealed.

2. The packaging body of a medical adhesive sheet according to claim 1, wherein the medical adhesive sheet is folded by winding the medical adhesive sheet so that the face of the resin film forms an outer surface.

3. The packaging body of a medical adhesive sheet according to claim 1, wherein the adhesive layer is formed from an acrylic adhesive.

4. The packaging body of a medical adhesive sheet according to claim 2, wherein the adhesive layer is formed from an acrylic adhesive.
